(19) United States
(12) Patent Application Publication
(10) Pub. No.: US 2025/0287243 A1
(43) Pub. Date: Sep. 11, 2025

(54) OVERHEAD AND LATENCY REDUCTION FOR BEAM REPORTS

(71) Applicant: Apple Inc., Cupertino, CA (US)

(72) Inventors: Yushu Zhang, Beijing (CN); Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Sigen Ye, Whitehouse Station, NJ (US); Wei Zeng, Saratoga, CA (US); Weidong Yang, San Diego, CA (US)

(21) Appl. No.: 18/858,566

(22) PCT Filed: Apr. 20, 2023
(86) PCT No.: PCT/US2023/019278

§ 371 Date: Oct. 21, 2024

Related U.S. Application Data
(60) Provisional application No. 63/333,359, filed on Apr. 21, 2022.

(51) Int. Cl. H04W 24/10; H04L 5/00

(52) U.S. Cl. CPC H04W 24/10; H04L 5/0057

(57) ABSTRACT

The disclosure relates to a method to be performed by a user equipment (UE). The method includes: receiving, from a base station, a beam report configuration that configures the UE to report measurements for a predetermined number of beam pairs, wherein the one or more beam pairs are arranged in a first Channel Measurement Resource (CMR) set and a second CMR set; determining that the first CMR set corresponds to a first repetition parameter and the second CMR set corresponds to a second repetition parameter; and transmitting, based on the first and second repetition parameters, a beam report to the base station. The disclosure also relates to another method as well as a UE.

### CROSS REFERENCE TO RELATED APPLICATIONS

This application claims priority to U.S. Provisional Patent Application No. 63/333,359, filed Apr. 21, 2022, the content of which is incorporated herein by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method to be performed by a user equipment (UE) is disclosed. The method includes: receiving, from a base station, a beam report configuration that configures the UE to report measurements for a predetermined number of beam pairs, wherein the one or more beam pairs are arranged in a first Channel Measurement Resource (CMR) set and a second CMR set; determining that the first CMR set corresponds to a first repetition parameter and the second CMR set corresponds to a second repetition parameter; and transmitting, based on the first and second repetition parameters, a beam report to the base station.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, the method includes a step in which the UE performs the measurements based on the beam report configuration.

In some implementations, the method includes a step in which the UE determines that the first repetition parameter is set to ON and the second repetition parameter is set to OFF. With this determination, the UE may report a Channel State Information Reference Signal (CSI-RS) Resource Indicator (CRI) for the first CMR set in the beam report while determining not to report the CRI for the second CMR set, or the UE may report the CRI for both CMR sets. Also with this determination, the UE may report an L1-RSRP for the first CMR set and the predetermined number of CRIs/Layer One Reference Signal Received Powers (L1-RSRPs) for the second CMR set.

In some implementations, the method includes a step in which the UE determines that the first repetition parameter and the second repetition parameter are both set to ON. With this determination, the UE may report a CRI for at least one of the first CMR set and the second CMR set. For example, the UE may report a CRI for the first CMR set and not for the second CMR set. Also with this determination, the UE may report an L1-RSRP for either the first CMR set or the second CMR set.

In some implementations, the beam report in the method includes an indicator that indicates whether the UE identifies the beam pairs as configured by the beam report configuration.

In some implementations, the first CMR set and the second CMR set of the method are scheduled within one slot in a number of overlapped symbols. In these implementations, the method includes one or more of the following steps: the UE reports a capability of measuring the overlapped first CMR set and second CMR set; the UE reports a maximum number of overlapped symbols between the first CMR set and the second CMR set; and the UE processes the first CMR set and the second CMR set in parallel using two processors. In alternative implementations, the first CMR set and the second CMR set are scheduled within one slot without overlapping each other.

In accordance with another aspect of the present disclosure, a method to be performed by a UE is disclosed. The method includes: transmitting, to a base station, a capability report indicating a plurality of antenna panels supported by the UE; receiving, from the base station, a signal that configures one or more antenna panels selected from the plurality of antenna panels; and transmitting, to the base station, a beam report using the one or more antenna panels. In this method, the beam report includes indices of the one or more antenna panels.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, each of the plurality of antenna panels in the method has a unique number of ports.

In some implementations, the one or more antenna panels are configured via bandwidth part (BWP) switching.

In some implementations, the signal that the UE receives in this method includes one or more of a Radio Resource Control (RRC) signal, a Media Access Control (MAC) Control Element (CE), and Downlink Control Information (DCI).

In accordance with another aspect of the present disclosure, a method to be performed by a base station is disclosed. The method includes: receiving, from a user equipment (UE), a capability report indicating a plurality of antenna panels supported by the UE; transmitting, to the UE, a signal that includes an indication of a subset of antenna panels selected from the plurality of antenna panels; and receiving, form the UE, a beam report includes indices of the subset of antenna panels.

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, each of the plurality of antenna panels has a unique number of ports.

In some implementations, the signal includes a Radio Resource Control (RRC) signal.

In some implementations, the signal includes a Media Access Control (MAC) Control Element (CE).

In some implementations, the signal includes Downlink Control Information (DCI).

In accordance with another aspect of the present disclosure, a UE in communication with a base station is disclosed. The UE includes: a receiver that receives, from the base station, a beam report configuration that configures the UE to report measurements for a predetermined number of beam pairs, wherein the one or more beam pairs are arranged in a first CMR set and a second CMR set; a processor that determines that the first CMR set corresponds to a first repetition parameter and the second CMR set corresponds to a second repetition parameter; and a transmitter that transmits, based on the first and second repetition parameters, a beam report to the base station.

In some implementations, the processor of the UE performs the measurements based on the beam report configuration.

In some implementations, the processor of the UE determines that the first repetition parameter is set to ON and the second repetition parameter is set to OFF. In some other implementations, the processor of the UE determines that the first repetition parameter is set to ON and the second repetition parameter is set to ON.

In some implementations of the UE, the first CMR set and the second CMR set are scheduled within one slot in a number of overlapped symbols.

In some implementations, the processor of the UE processes the first CMR set and the second CMR set in parallel.

In some implementations of the UE, the first CMR set and the second CMR set are scheduled within one slot without overlapping each other.

The details of one or more implementations of these UEs and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example wireless network, according to some implementations.

FIG. 2 illustrates an example group-based beam reporting procedure, according to some implementations.

FIG. 3A illustrates an example enhanced beam report, according to some implementations.

FIG. 3B illustrates another example enhanced beam report, according to some implementations

FIG. 4 illustrates a minimal processing delay in Channel State Information (CSI) reporting, according to some implementations.

FIG. 5A illustrates an example scheduling of two CMR sets, according to some implementations.

FIG. 5B illustrates an example processing configuration for processing two CMR sets shown in FIG. 5A, according to some implementations.

FIG. 5C illustrates an example processing configuration for processing two CMR sets shown in FIG. 5A, according to some implementations.

FIGS. 5A and 5B each illustrate an example of CMR processing with latency reduction, according to some implementations.

FIG. 6 illustrates an example of a MAC CE, according to some implementations.

FIG. 7 illustrates a flowchart of an example method, according to some implementations.

FIG. 8A illustrates a flowchart of another example method, according to some implementations.

FIG. 8B illustrates a flowchart of another example method, according to some implementations.

FIG. 9 illustrates an example UE, according to some implementations.

FIG. 10 illustrates an example access node, according to some implementations.

### DETAILED DESCRIPTION

Recent releases of the Third Generation Partnership Project (3GPP) standards have discussed beam reporting schemes carried out by a UE and a base station in a wireless network. While the beam reporting schemes are introduced to facilitate beam selection, the schemes involve extra channel measurement and reporting, which may further incur processing overhead and latency.

This disclosure describes overhead and latency reduction for some beam reporting schemes. The disclosure discusses, among other things, overhead reduction based on a repetition parameter configured along with a channel measurement report (CMR) set, latency reduction based on the time-domain arrangement of multiple CMR sets, and overhead reduction based on antenna panel configurations.

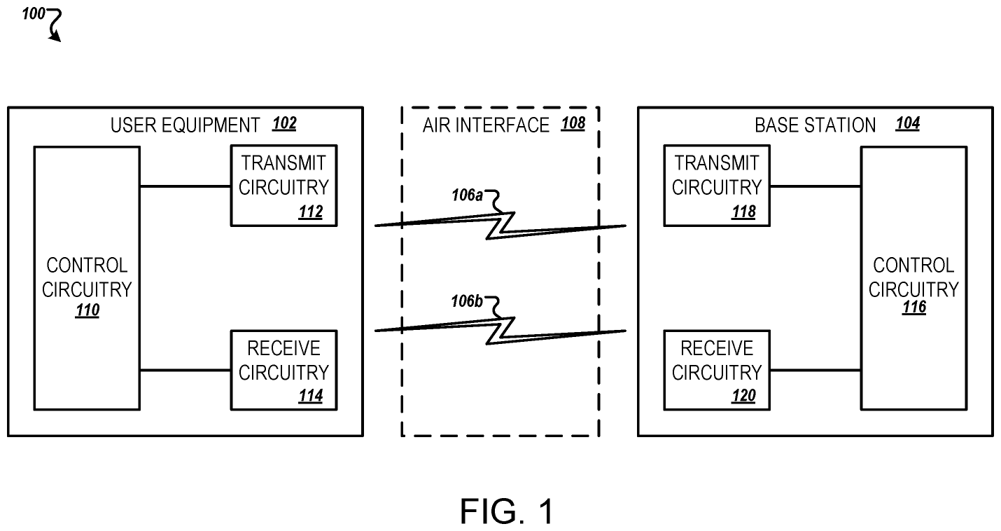

FIG. 1 illustrates an example wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G NR communication standards as defined by the 3GPP technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

Release 15 and Release 16 of the 3GPP standards describe a beam reporting procedure that facilitates beam selection. Under this beam reporting procedure, a base station (e.g., the base station 104) transmits a beam report configuration to configure a UE (e.g., the UE 102) to measure and report a number of beams along with the beam quality. Example metrics of beam quality include Layer One Reference Signal Received Power (L1-RSRP) and L1 Signal-to-Interference-and-Noise Ratio (L1-SINR). For instance, among a total number of N listed beams, the base station may configure the UE to measure and report K (K<=N) beams, where K can be, for example, 1, 2, 3, or 4. The beam report configuration is based on a channel state information (CSI) framework, and is provided to the UE via an information element called CSI-reportConfig (e.g., described in 3GPP TS 38.331 Section 6.3.2). Each instance of the CSI-reportConfig can configure a respective beam report.

Release 15 and Release 16 further describe that different Synchronization Signal Blocks (SSBs) or CSI reference signals (CSI-RSs) can be transmitted on different beams. In some instances, the SSBs or CSI-RSs are configured and arranged in a channel measurement resource (CMR) set. Each CMR set may include multiple SSBs or CSI-RSs. Further, each CMR set may correspond to a repetition parameter that is switchable between “ON” and “OFF.” For the CSI-RSs in a CMR set, the corresponding repetition parameter set to “ON” may indicate that the CSI-RSs are associated with the same antenna ports. In some instances, a UE may assume that the CSI-RSs associated with the same antenna port are transmitted on the same beam. This setting may be used for UE beam refinement, where the UE may use different beams to receive different CSI-RSs to determine a preferred receive beam to receive transmissions.

Release 17 of the 3GPP standards introduced two new features of the beam reporting procedure. The first feature is a group-based beam report. In this feature, a base station may include two (or more) transmission/reception points (TRPs). The base station may configure two CMR sets for simultaneous downlink transmission, where each CRM set is transmitted from one of the TRPs. As such, a UE may measure and report K beam pairs rather than K single beams, where each beam pair includes two beams, one from each CMR set. The UE may receive the two beams in each pair simultaneously. The group-based beam report includes a CSI resource indicator (CRI) or beam index that identifies each beam within a CMR set. The UE can use the CRI to indicate a preferred CSI-RS beam from the CMR set. The group-based beam report procedure thus differs from previous beam reporting procedures that perform beam measurement and reporting on a single-beam basis.

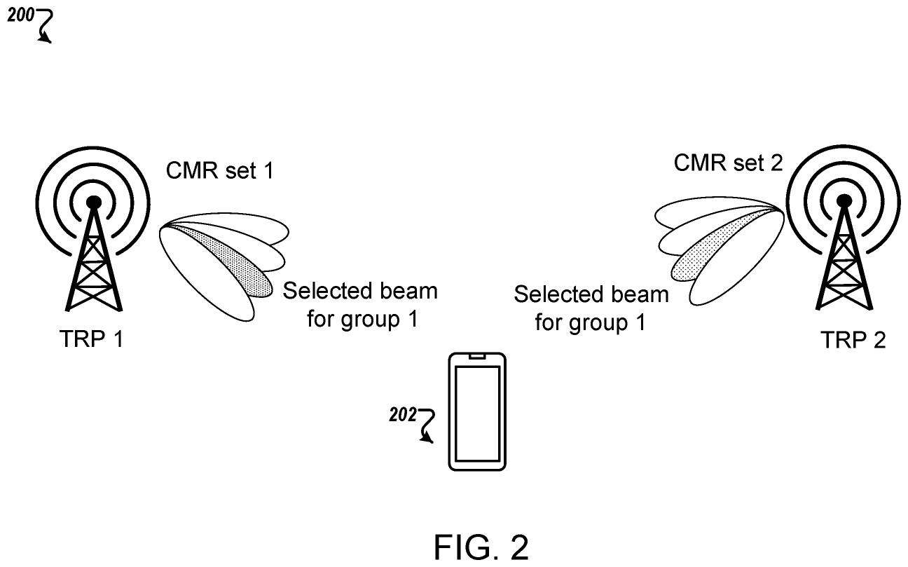

FIG. 2 illustrates an example group-based beam reporting procedure 200, according to some implementations. In FIG. 2, a base station includes TRP 1 and TRP 2, each corresponding a CMR set: CMR set 1 and CMR set 2, respectively. In this example, CMR set 1 and CMR set 2 each support four beams. One beam from each of the CMR sets is selected and the two selected beams form a beam pair (e.g., resource group 1) for communicating with a UE 202. Although the implementations described herein assume two beams per group, it is possible that some implementations have more than two beams per group.

The second beam reporting feature introduced in Release 17 is a panel selection feature. In this feature, a UE may report its panel entity index (also referred to as a “capability index”) for each reported SSB/CSI-RS in a beam report. The panel entity index that is reported in the beam report corresponding to a particular SSB or CSI-RS may serve as an indication to the base station that the UE will use a particular panel corresponding to the panel entity index for uplink transmissions. Further, for each panel, the UE may report a maximum number of ports (e.g., Sounding Reference Signal [SRS] ports) that the panel can support. In some instances, panels that support different numbers of SRS ports are assumed to be of different types. In an example, a UE may use the beam report to report how many different types of panels it supports. Here, the term “panel” refers to an array of UE antennas with the same direction. Different panels are assumed to have different antenna directions. Reporting the panel indices and the maximum number of supported panel types may advantageously facilitate panel selection by the base station.

This disclosure describes methods and systems for reducing the overhead and latency of the two Release 17 beam report features described above. In particular, the disclosed methods and systems achieve: (i) an overhead reduction for group-based beam reporting when the repetition parameter is set to “ON;” (ii) a latency reduction for group-based beam reporting that allows a base station to schedule two CMR sets without incurring delays; and (iii) an overhead reduction for the capability index report in the panel selection feature.

In some implementations, a UE is configured to generate an enhanced group-based beam report. The enhanced group-based beam report reduces an overhead for the group-based beam report when the repetition parameter is set to “ON” by foregoing the reporting of at least one CRI in the report. As discussed previously, each CMR set corresponds to a repetition parameter, which, if set to “ON,” causes the CSI-RSs to be transmitted via the same beam. Thus, if the UE determines that the repetition parameter of a CMR set is set to “ON,” it is not necessary for the UE to report the CRI since each CSI-RS in the CMR set is transmitted on the same beam, and the CRI would only indicate the same beam. With this feature, overhead may be reduced by decreasing the frequency of, or eliminating altogether, the reporting of CRI for CMR sets for which the repetition parameter is set to “ON.”

In a group-based beam report, however, the UE may need to handle more than one CMR set, and different options may be considered for the UE based on whether one or both of the CMR sets are configured for repetition (i.e., CSI-RS in the CMR set transmitted on the same beam). In a first scenario, one of the CMR sets may be configured for repetition while the other CMR set may not be configured for repetition. In this scenario, the UE determines that the repetition parameter is set to “ON” for a first CMR set and set to “OFF” for a second CMR set.

In some implementations, the UE is configured to select one of one or more options in this scenario. In a first option, the UE is configured to report the CRI for the second CMR set but not for the first CMR set because the first CMR set is configured for repetition with CSI-RS transmitted on the same beam. In a second option, the UE is configured to report the CRIs for both the first CMR set and the second CMR set. In some examples, if K (K>1) beam pairs are configured to be reported, the UE may report the L1-RSRP of only one beam for each CMR set with the repetition parameter set to “ON.” Conversely, for each CMR set with the repetition parameter set to “OFF,” the UE may report the L1-RSRPs of all K beams.

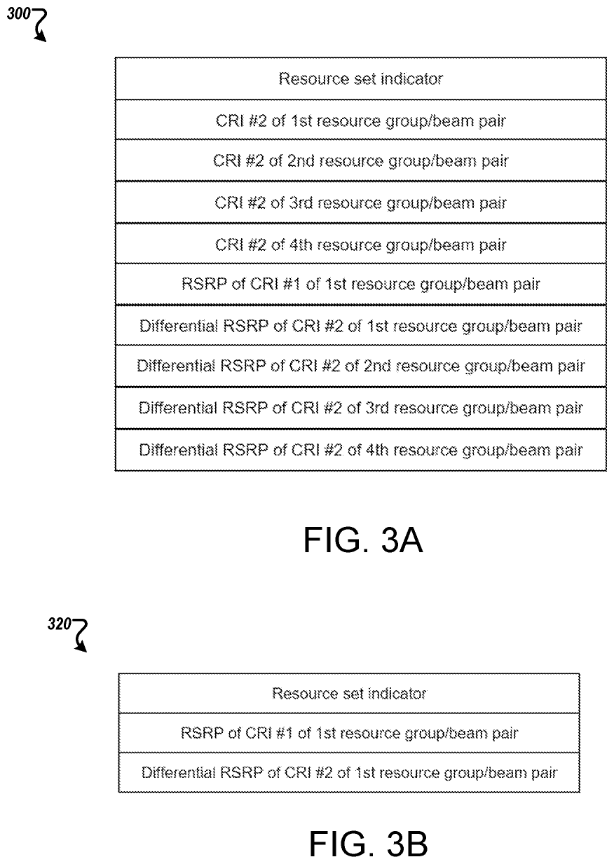

FIG. 3A illustrates an example enhanced beam report 300, according to some implementations. In this example, a UE (not illustrated) is reporting measurements associated with two CRM sets: CRM set 1 and CRM set 2. Accordingly, the enhanced beam report 300 can include two CRIs: a first CRI labeled as “CRI #1” and a second CRI labeled as “CRI #2.” The beam report 300 includes a resource set indicator that specifies whether the first CRI (i.e., CRI #1) is associated with the first CRM set or the second CRM set. In this example, the resource set indicator specifies that the CRI #1 is associated with the first CRM set.

In the example of FIG. 3A, the repetition parameter is set to “ON” for the first CMR set and set to “OFF” for the second CMR set, and four beam pairs (also referred to as resource groups) are configured for measurement (i.e., K=4). Accordingly, the UE can select one of the one or more previously described options. In the first option, the UE reports the CRI for the second CMR set, but not for the first CMR set. In the second option, the UE reports the CRIs for both CMR sets. In the example of FIG. 3A, the UE selects the first option. Accordingly, as shown in FIG. 3A, the UE does not report the CRI for the first CMR set and reports the CRIs for all four beam pairs of the second CMR set. As also shown in FIG. 3A, the UE reports the L1-RSRP of only one beam for the first CMR set and reports the L1-RSRPs of all four beams for the second CMR set. Note that RSRP is reported for the strongest beam and differential RSRP is reported for other beams.

In a second scenario of group-based beam reporting, a UE determines that the repetition parameter is set to “ON” for both CMR sets. In this scenario, the UE is configured to select one of one or more options when generating an enhanced group-based beam report. In a first option, the UE is configured to report the CRI for one CMR set but not for the other CMR set. In a second option, the UE is configured to not report the CRIs for either CMR set. In a third option, the UE is configured to report the CRIs for both of the first CMR set and the second CMR set. For all three options, even if K (K>1) beam pairs are configured to be reported, the UE may report the L1-RSRP of only one beam pair.

FIG. 3B illustrates another example enhanced beam report 320, according to some implementations. In this example, a UE is reporting measurements associated with two CRM sets: CRM set 1 and CRM set 2. Accordingly, the enhanced beam report 320 can include two CRIs: a first CRI labeled as “CRI #1” and a second CRI labeled as “CRI #2.” Like in the enhanced beam report 300 of FIG. 3A, the resource set indicator of the beam report 320 specifies that CRI #1 is associated with the first CRM set. However, in this example, the repetition parameter is set to “ON” for both CMR sets. Accordingly, the UE can select one of the previously described options for reporting CRI. In this example, the UE selects the option of not reporting the CRI for either the first CMR set or the second CMR set. Thus, as shown in FIG. 3B, the enhanced beam report 320 does not include CRI. Rather, the enhanced beam report 320 only includes the L1-RSRP of only one beam from each CMR set.

In some implementations, the UE may report that it cannot identify or detect any beam pair to be received simultaneously. In these implementations, the UE may include in the beam report an indicator, on a per-report basis or on a per-beam-pair basis, that indicates whether the UE identifies a beam pair or not. Additionally or alternatively, if the UE cannot identify any beam pairs, the UE may determine to not report the enhanced beam report. Furthermore, in the previous description, CRI was used as an identifier of the beams. However, SSBRI (SS/PBCH Resource Block Indicator) can additionally or alternatively be used as the identifier.

In addition to the overhead reduction features for group-based beam reports described above, features for reducing latency in group-based beam reports are also included in the present disclosure. In order to under the latency reduction features, it is helpful to understand how beam reports are currently processed by a UE.

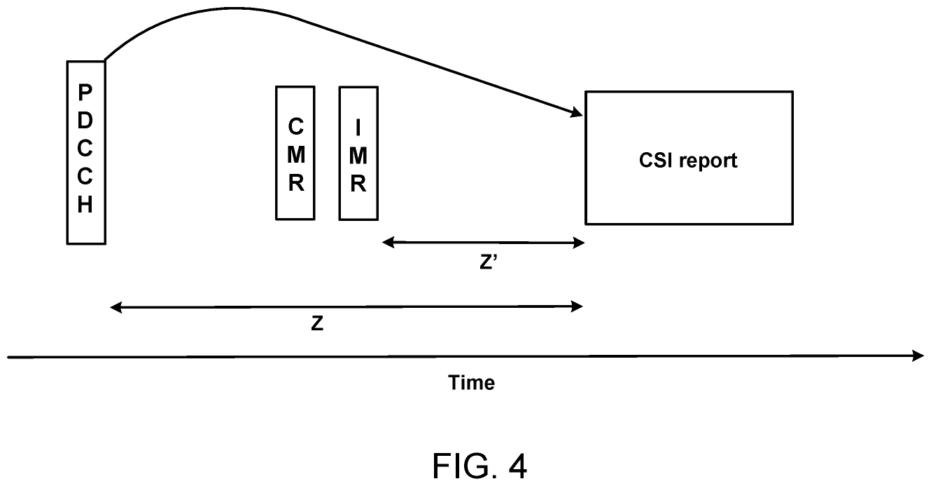

By way of background, Release 15 and Release 16 of the 3GPP specifications describe that for an aperiodic beam/CSI report, the base station scheduling follows a minimal Z and Z′ requirement, as illustrated in FIG. 4. Here, Z is defined as an offset between a last symbol of a physical downlink control channel (PDCCH) and a first symbol of a beam report. Z′ is defined as the offset between: (i) the last symbol of CMR or an Interference Measurement Resource (IMR) and (ii) the first symbol of the beam/CSI report. In other words, Z′ is the minimum offset between the time at which the UE completes processing of CMR/IMR and the time at which the beam report is generated. The 3GPP specifications specify that the beam/CSI report should be scheduled such that the Z and Z′ values of the scheduled beam/CSI report are greater than minimal values of Z and Z′. If a base station schedules a beam/CSI report with a Z and Z′ values that are less than the minimal values of Z and Z′, then the UE could incorrectly report the quality for an outdated beam/CSI. Note that, in some scenarios, the CMR is scheduled independently of the IMR. In these scenarios Z′ is defined as the offset between (i) the last symbol of CMR and (ii) the first symbol of the beam/CSI report.

Additionally, Release 15 and Release 16 describe a CSI processing unit for a UE. The CSI processing unit is a logical entity that includes a set of processing resources dedicated, at least in part, for processing CSI measurements and generating beam reports. The CSI processing unit is described in more detail in 3GPP TS 38.214 Section 5.2.1.6. The 3GPP specifications specify that each beam report (which corresponds to a respective CSI-reportConfig received from the base station) is assumed to occupy one CSI processing unit. Furthermore, when a CSI processing unit is occupied for a task, the CSI processing unit cannot perform other tasks.

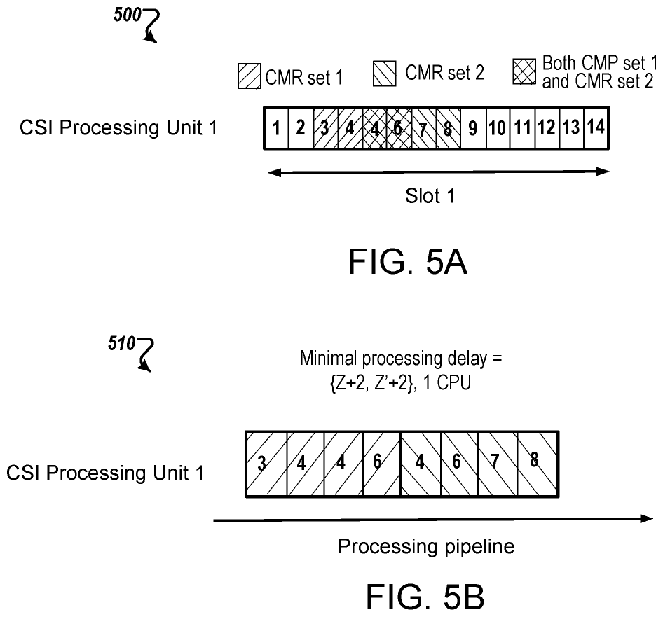

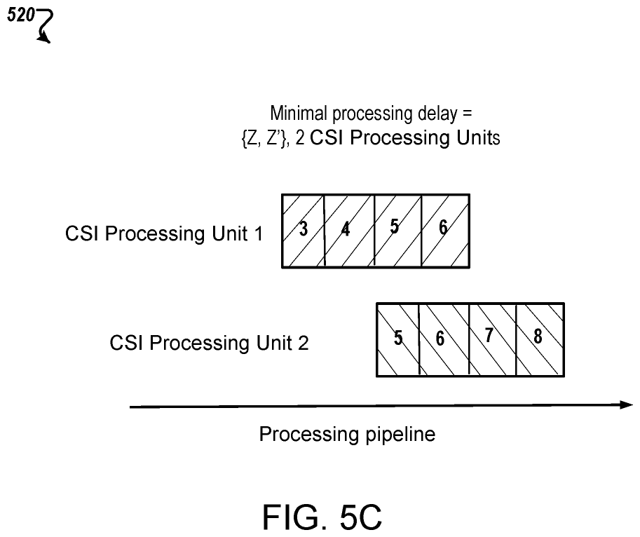

In some implementations, a UE that receives a beam reporting configuration that includes two CMR sets (i.e., group-based beam reporting) is configured to schedule and transmit two CMR sets within one slot, possibly with the same scheduling offset. This reduces the latency of performing the group-based beam reporting. However, in some scenarios, the two CMR sets overlap in time domain (e.g., scheduled in one or more overlapped symbols). Because the two CMR sets are part of the same beam reporting configuration, they are assigned to the one CSI processing unit. As a result, in these scenarios, the UE would have less resources available for processing in the overlapping symbols, which may cause latency in the group-based beam reporting. This problem is shown in FIG. 5A.

FIG. 5A illustrates a scheduling 500 of two CMR sets, according to some implementations. As shown in FIG. 5A, a base station has scheduled two CMR sets in the same slot to reduce latency. Specifically, the two CMR sets are scheduled in symbols 3-8 of the slot: CMR set 1 occupies symbols {3, 4, 5, 6}, and CMR set 2 occupies symbols {5, 6, 7, 8}. Because the two CMR sets are part of the same beam reporting configuration, they are assigned to the one CSI processing unit: CSI processing unit 1. Furthermore, the two CMR sets overlap in time domain (e.g., scheduled in one or more overlapped symbols), namely in symbols 5 and 6. During symbols 5 and 6, the UE has fewer resources available for processing than in the other symbols, which may cause latency. To this end, the UE is configured with one or more options for reducing latency in scenarios where the processing of the two CMR sets overlaps in time.

In a first option for reducing latency, the UE is configured with a new minimal required delay values (previously shown as Z and Z′ in FIG. 2). In this option, called Latency Reduction Option 1, instead of requiring that the UE report the beam report according to the previously defined values of Z and Z′, the base station configures the UE to report the group-based beam report according to new minimal required delay values of Z+d and Z′+d, where d is a predetermined offset. This new minimal required delay values provide the UE with additional time for processing the group-based beam report. This allows the UE to delay the processing of one of the CMR sets instead of processing the CMR sets in an overlapping time period. In other words, the UE can process the two CMR sets in series. In one example, the offset, d, is calculated as d=ceil(S*X). In this equation, S is a variable that can be predefined or configured by base station signaling (e.g., higher layer signaling, such as RRC signaling), and X is a number of overlapped symbols.

FIG. 5B illustrates an example processing configuration 510 for processing two CMR sets shown in FIG. 5A, according to some implementations. In particular, the processing configuration 510 is a result of applying new minimal delay values to the scheduling 500 of FIG. 5A. As explained, the new minimal required delay values provide the UE with additional time for processing the group-based beam report than would otherwise be available to the UE. Accordingly, the CSI processing unit 1 can be used to process the two CMR sets in series. Although this processing takes additional time due to the symbols {5, 6} being processed twice, the new minimal required delay values account for this delay.

In a second option for reducing latency, the UE is configured to process two overlapping CMR sets in parallel using two CSI processing units. As a result of using two CSI processing units, the UE can complete the processing of the overlapping CMR sets under the original time requirements (i.e., the original minimal required delay values without the added offset). In this option, called Latency Reduction Option 2, both CSI processing units may be occupied starting from the first symbol for both CMR sets. An occupied CSI processing unit cannot be used for other processes. Alternatively, each CSI processing unit may be occupied starting from the first symbol for the corresponding CMR set.

FIG. 5C illustrates an example processing configuration 520 for processing two CMR sets, according to some implementations. In particular, the processing configuration 510 is a result of applying new minimal delay values to the scheduling 500 of FIG. 5A. In this example, two CSI processing units are used to process the two CMR sets in parallel: CSI processing unit CSI processing unit 1 starts processing CMR set 1 at symbol {3} and CSI processing unit 2 starts processing CMR set 2 at symbol {5}. Despite the overlapped symbols {5, 6}, parallel processing by the two CSI processing units does not incur additional delay. Therefore, new minimal required delay values are not needed.

In some implementations, the UE is configured to support both Latency Reduction Option 1 and Latency Reduction Option 2. With both options supported by the UE, the base station may configure the UE to switch between the two options. Additionally or alternatively, the UE may report to the base station which option is used.

In some implementations, the UE 102 may report whether it has the capability to process measurement of CMR sets that overlap in time domain. Even if the UE 102 has the capability to process time domain overlapping CMR sets, it is possible the capability is limited by a maximum number of overlapped symbols. For example, the UE 102 may be able to handle overlapping CMR sets but may be able to process only up to X number of overlapped symbols. Thus, in some implementations, the UE 102 may report the maximum number of overlapped symbols in the CMR sets that the UE 102 can process.

Features can also be implemented to reduce overhead signaling for the panel entity index reporting feature. As discussed above, this feature can contribute to a beam report enhancement for panel selection. In this scheme, the UE transmits a UE capability report to indicate the number of different types of panels that are supported by the UE. Upon receiving the UE capability report, the base station may use bandwidth part (BWP) switching to change the panels identified by the UE. The base station may configure N UL BWPs for one component carrier, where each BWP corresponds to one of M panel types identified by the UE. This correspondence may be established by aligning LI parameters for the BWP with the UE capability for that panel. By activating different BWPs, the base station may switch the panel of the UE.

In some implementations, to reduce overhead signaling for panel entity index reporting, the number N may be less than the number M. That is, it is not necessary for the base station to configure one UL BWP for each panel type because this configuration may lead to a relatively large overhead. Instead, although M panel types are identified by the UE, the base station may configure the UE to use fewer panel types. For example, the UE may identify in UE capability report three panel types with number of ports being one, two, and four, respectively. Meanwhile, the base station may configure the UE to use only two panel types with number of ports being one and two, respectively. In this case, the unconfigured four-port panel may be regarded as a virtualized one-port panel using antenna virtualization in the communication with the base station. In the beam report, the UE identifies the panel types that are configured by the base station, but does not need to include in the beam report the panel types for which the base station does not configure. This leads to a reduction of overhead.

In some implementations, a base station is configured to select one of one or more options to communicate the configured panel types, according to some implementations. In a first option, Panel Configuration Option 1, the base station is configured to communicate a list of configured panel types with different maximum number of SRS ports using RRC signaling. The RRC signaling may be provided for each beam report configuration (e.g., CSI-reportConfig), BWP, serving cell, or serving cell group.

In a second option, Panel Configuration Option 2, the base station is configured to communicate a list of panel types with different maximum number of SRS ports using a MAC CE. In one example, the base station uses a MAC CE used to trigger a semi-persistent beam report, perhaps by adding additional fields to that MAC CE to indicate the panel types.

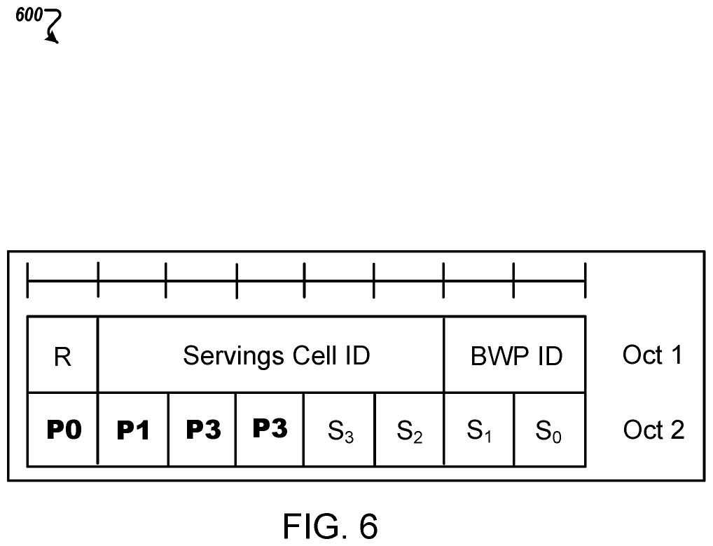

FIG. 6 illustrates an example MAC CE structure 600, according to some implementations. This example assumes up to four panel types may be configured. As shown in FIG. 6, P0-P3 are added to the second octet (Oct 2) as indicators of whether each of the four panel types is configured by the base station.

In a third option, Panel Configuration Option 3, the base station is configured to communicate a list of configured panel types with different maximum number of SRS ports using downlink control information (DCI). For example, similar to Panel Configuration Option 2, a bitmap may be introduced to the DCI data structure with a number of fields indicating whether each of the panel types is configured by the base station. In another example, the base station may first use RRC signaling to notify the UE of a number of lists as possible candidates for configuration, where each list includes different combinations of panel types configured by the base station. The base station may then use DCI to select a list for the UE to transmit the beam report.

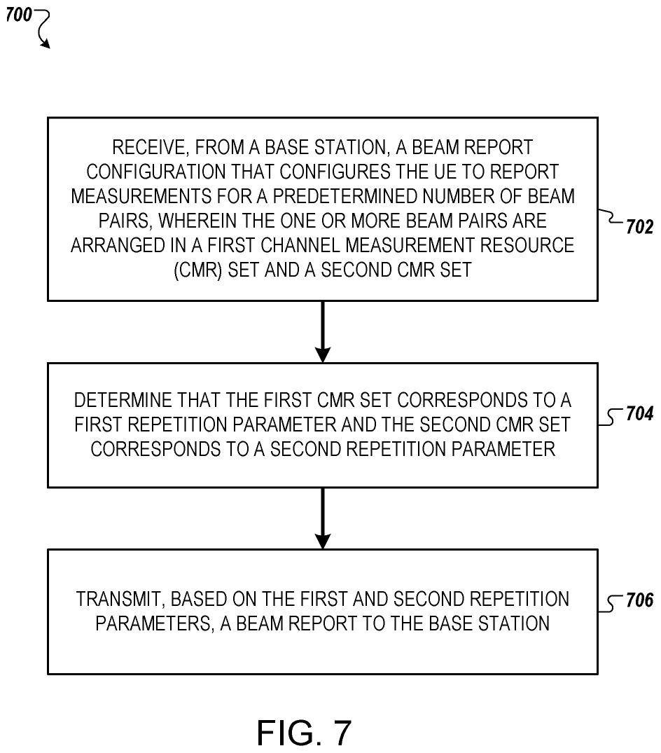

FIG. 7 illustrates a flowchart of an example method 700 performed by a UE, in accordance with some implementations. The method 700 may be performed by the UE 102, which is described above with reference to FIGS. 1-5, or any other suitable devices or systems. Moreover, although steps of the method 700 are numbered in order, implementations of this method are not required to execute the steps in the order they are numbered. It is possible that some implementations execute these steps in different orders or in parallel.

At step 702, the UE receives, from a base station, a beam report configuration that configures the UE to report measurements for a predetermined number of beam pairs, wherein the one or more beam pairs are arranged in a first CMR set and a second CMR set.

At step 704, the UE determines that the first CMR set corresponds to a first repetition parameter and the second CMR set corresponds to a second repetition parameter.

At step 706, the UE transmits, based on the first and second repetition parameters, a beam report to the base station.

In some implementations, the method 700 may further include a step in which the UE performs the measurements based on the beam report configuration.

In some implementations, the method 700 may further include a step in which the UE determines that the first repetition parameter is set to ON and the second repetition parameter is set to OFF. With this determination, the UE may report a CRI for the first CMR set in the beam report while determining not to report the CRI for the second CMR set, or the UE may report the CRI for both CMR sets. Also with this determination, the UE may report an L1-RSRP for the first CMR set and the predetermined number of CRIs/L1-RSRPs for the second CMR set.

In some implementations, the method 700 may additionally or alternatively include a step in which the UE determines that the first repetition parameter and the second repetition parameter are both set to ON. With this determination, the UE may report a CRI for at least one of the first CMR set and the second CMR set. For example, the UE may report a CRI for the first CMR set and not for the second CMR set. Also with this determination, the UE may report an L1-RSRP for either the first CMR set or the second CMR set.

In some implementations, the beam report in the method 700 may include an indicator that indicates whether the UE identifies the beam pairs as configured by the beam report configuration.

In some implementations, the first CMR set and the second CMR set of the method 700 may be scheduled within one slot in a number of overlapped symbols. In these implementations, the method 700 may further include one or more of the following steps: the UE reports a capability of measuring the overlapped first CMR set and second CMR set; the UE reports a maximum number of overlapped symbols between the first CMR set and the second CMR set; and the UE processes the first CMR set and the second CMR set in parallel using two processors. In alternative implementations, the first CMR set and the second CMR set may be scheduled within one slot without overlapping each other.

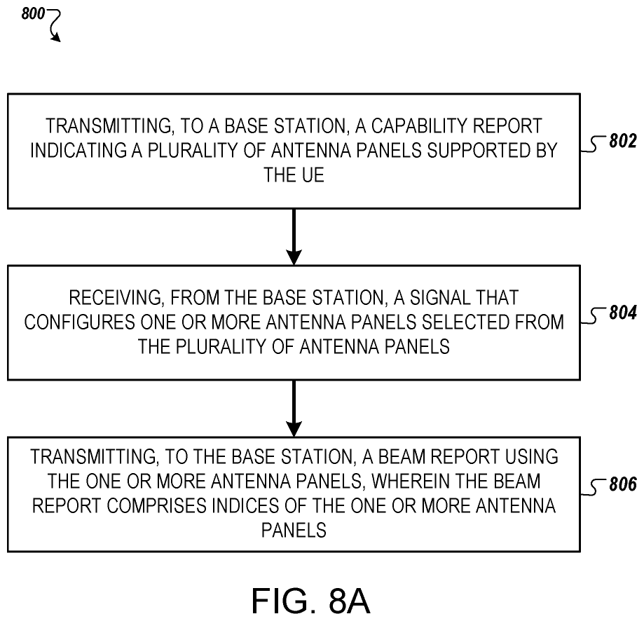

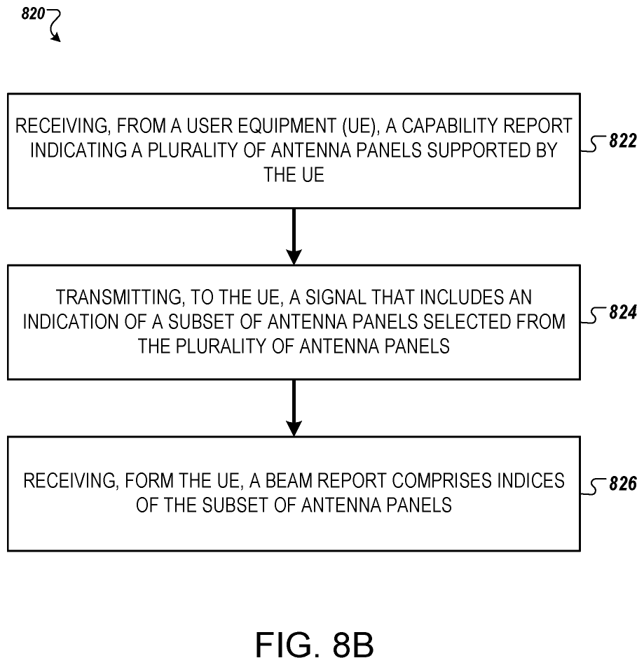

FIG. 8A illustrates a flowchart of an example method 800, in accordance with some implementations. The method 800 may be performed by the UE 102, which is described above with reference to FIGS. 1-5, or any other suitable devices or systems. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order.

At step 802, the UE transmits, to a base station, a capability report indicating a plurality of antenna panels supported by the UE.

At step 804, the UE receives, from the base station, a signal that configures one or more antenna panels selected from the plurality of antenna panels.

At step 806, the UE transmits, to the base station, a beam report using the one or more antenna panels. The beam report includes indices of the one or more antenna panels.

In some implementations, each of the plurality of antenna panels in the method 800 may have a unique number of ports.

In some implementations, the one or more antenna panels may be configured via BWP switching.

In some implementations, the signal that the UE receives at step 804 may include one or more of an RRC signal, a MAC CE, and DCI.

FIG. 8B illustrates a flowchart of an example method 820, in accordance with some implementations. The method 820 may be performed by the base station 104, which is described above with reference to FIG. 1, or any other suitable devices or systems. It will be understood that method 820 can be performed, for example, by any suitable system, environment, software, hardware, or a combination of systems, environments, software, and hardware, as appropriate. In some implementations, various steps of method V100 can be run in parallel, in combination, in loops, or in any order.

At step 822, method 820 involves receiving, from a user equipment (UE), a capability report indicating a plurality of antenna panels supported by the UE.

At 824, method 820 involves transmitting, to the UE, a signal that includes an indication of a subset of antenna panels selected from the plurality of antenna panels.

At 826, method 820 involves receiving, form the UE, a beam report includes indices of the subset of antenna panels.

In some implementations, each of the plurality of antenna panels has a unique number of ports.

In some implementations, the signal includes a Radio Resource Control (RRC) signal.

In some implementations, the signal includes a Media Access Control (MAC) Control Element (CE).

In some implementations, the signal includes Downlink Control Information (DCI).

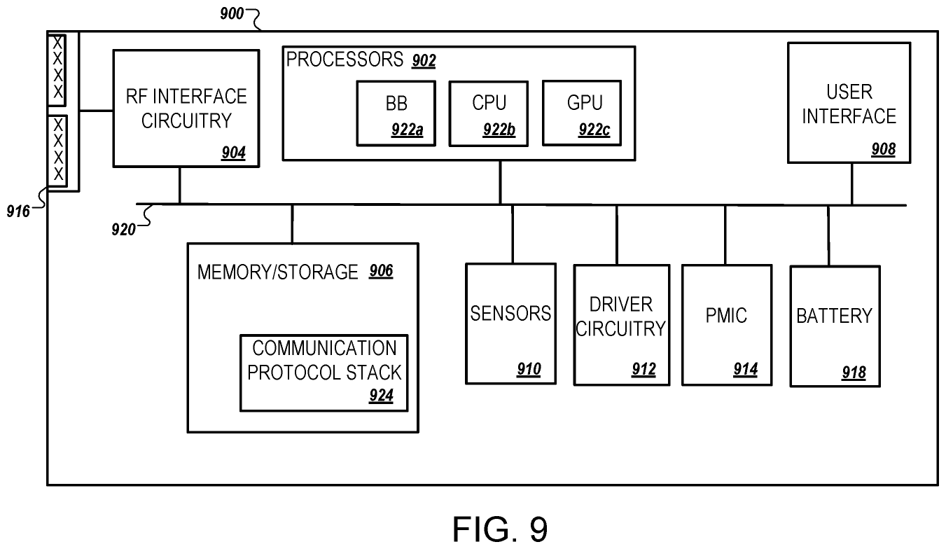

FIG. 9 illustrates an example UE 900, according to some implementations. The UE 900 may be similar to and substantially interchangeable with UE 102 of FIG. 1.

The UE 900 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, antenna structure 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 916. In various implementations, the RF interface circuitry 904 may be configured to transmit/receive signals in a manner compatible with NR access technologies.

The antenna 916 may include antenna elements to convert electrical signals into radio waves to travel through the air and to convert received radio waves into electrical signals. The antenna elements may be arranged into one or more antenna panels. The antenna 916 may have antenna panels that are omnidirectional, directional, or a combination thereof to enable beamforming and multiple input, multiple output communications. The antenna 916 may include microstrip antennas, printed antennas fabricated on the surface of one or more printed circuit boards, patch antennas, phased array antennas, etc. The antenna 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensor circuitry 928 and control and allow access to sensor circuitry 928, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

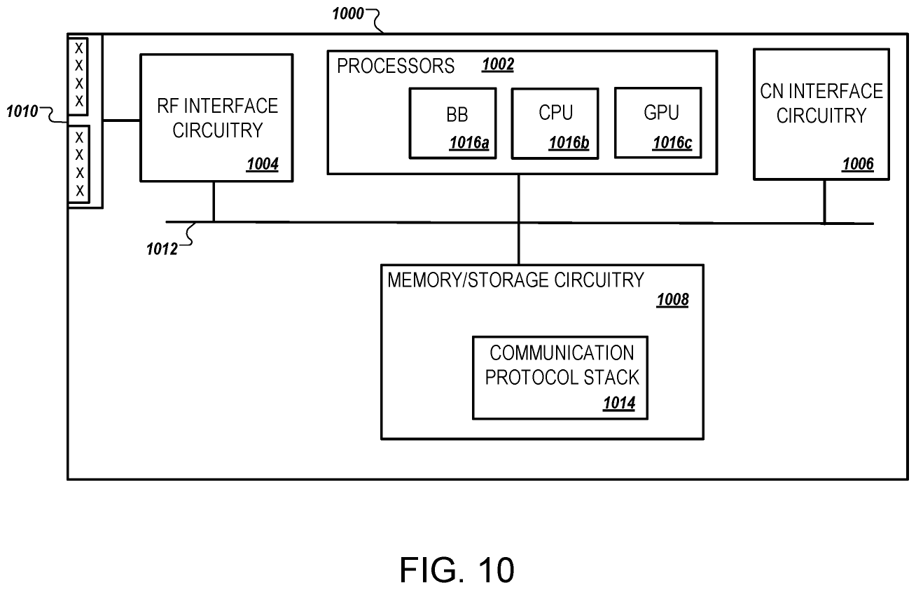

FIG. 10 illustrates an example access node 1000 (e.g., a base station or gNB), according to some implementations. The access node 1000 may be similar to and substantially interchangeable with base station 104. The access node 1000 may include processors 1002, RF interface circuitry 1004, core network (CN) interface circuitry 1006, memory/storage circuitry 1008, and antenna structure 1010.

The components of the access node 1000 may be coupled with various other components over one or more interconnects 1012. The processors 1002, RF interface circuitry 1004, memory/storage circuitry 1008 (including communication protocol stack 1014), antenna structure 1010, and interconnects 1012 may be similar to like-named elements shown and described with respect to FIG. 9. For example, the processors 1002 may include processor circuitry such as, for example, baseband processor circuitry (BB) 1016A, CPU 1016B, and GPU 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In V2X scenarios, the access node 1000 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section

### EXAMPLE

In the following sections, further exemplary implementations are provided.

Example 1 includes one or more processors. The one or more processors are configured to execute instructions that cause a UE to perform operations. The operations include receiving, from a base station, a beam report configuration that configures the UE to report measurements for a predetermined number of beam pairs, wherein the one or more beam pairs are arranged in a first Channel Measurement Resource (CMR) set and a second CMR set. The operations include determining that the first CMR set corresponds to a first repetition parameter and the second CMR set corresponds to a second repetition parameter. The operations include transmitting, based on the first and second repetition parameters, a beam report to the base station.

Example 2 may include the one or more processors of Example 1. The operations in Example 2 further include performing the measurements based on the beam report configuration.

Example 3 may include the one or more processors of Example 1 or 2. The operations in Example 3 further include determining that the first repetition parameter is set to ON and the second repetition parameter is set to off.

Example 4 may include the one or more processors of Example 3. The operation of transmitting, based on the first and second repetition parameters, a beam report to the base station includes: reporting a Channel State Information Reference Signal (CSI-RS) Resource Indicator (CRI) for the first CMR set in the beam report and determine not to report the CRI for the second CMR set.

Example 5 may include the one or more processors of Example 3. The operations in Example 5 further include reporting a Channel State Information Reference Signal (CSI-RS) Resource Indicator (CRI) for both the FIRST CMR set and the second CMR set.

Example 6 may include the one or more processors of any of Examples 3 to 5. The operations in Example 6 further include reporting a Layer One Reference Signal Received Power (L1-RSPR) for the first CMR set and reporting the predetermined number of CRIs/L1-RSRPs for the second CMR set.

Example 7 may include the one or more processors of Example 1 or 2. The operations in Example 7 further include determining that the first repetition parameter is set to ON and the second repetition parameter is set to ON.

Example 8 may include the one or more processors of Example 7. The operations in Example 8 further include reporting a Channel State Information Reference Signal (CSI-RS) Resource Indicator (CRI) for at least one of the first CMR set and the second CMR set.

Example 9 may include the one or more processors of Example 7. The operations in Example 9 further include determining not to report a Channel State Information Reference Signal (CSI-RS) Resource Indicator (CRI) for the first CMR set and not to report the CRI for the second CMR set.

Example 10 may include the one or more processors of any of Examples 7 to 9. The operations in Example 10 further include reporting one Layer One Reference Signal Received Power (L1-RSRP) for either the first CMR set or the second CMR set.

Example 11 may include the one or more processors of any of Examples 1 to 10. The beam report includes an indicator that indicates whether the UE identifies the beam pairs.

Example 12 may include the one or more processors of any of Examples 1 to 11,wherein the first CMR set and the second CMR set are scheduled within one slot in a number of overlapped symbols.

Example 13 may include the one or more processors of Example 12. The operations in Example 13 further include reporting a capability of measuring the overlapped first CMR set and second CMR set.

Example 14 may include the one or more processors of Example 12 or 13. The operations in Example 14 further include reporting a maximum number of overlapped symbols between the first CMR set and the second CMR set.

Example 15 may include the one or more processors of any of Examples 12 to 14. The operations in Example 15 further include processing the first CMR set and the second CMR set in parallel using two processors.

Example 16 may include the one or more processors of any of Examples 1 to 11, wherein the first CMR set and the second CMR set are scheduled within one slot without overlapping each other.

Example 17 includes one or more processors. The one or more processors are configured to execute instructions that cause a user equipment (UE) to perform operations. The operations in Example 17 include transmitting, to a base station, a capability report indicating a plurality of antenna panels supported by the UE. The operations include receiving, from the base station, a signal that configures one or more antenna panels selected from the plurality of antenna panels. The operations include transmitting, to the base station, a beam report using the one or more antenna panels, wherein the beam report includes indices of the one or more antenna panels.

Example 18 may include the one or more processors of Example 17, wherein each of the plurality of antenna panels has a unique number of ports.

Example 19 may include the one or more processors of Example 17 or 18, wherein the one or more antenna panels are configured via bandwidth part (BWP) switching.

Example 20 may include the one or more processors of any of Examples 17 to 19, wherein the signal includes a Radio Resource Control (RRC) signal.

Example 21 may include the one or more processors of any of Examples 17 to 19, wherein the signal includes a Media Access Control (MAC) Control Element (CE).

Example 22 may include the one or more processors of any of Examples 17 to 19, wherein the signal includes Downlink Control Information (DCI).

Example 23 includes one or more processors. The processors are configured to execute instructions that cause a base station to perform operations. The operations in Example 23 include receiving, from a user equipment (UE), a capability report indicating a plurality of antenna panels supported by the UE. The operations include transmitting a signal to the UE that includes an indication of a subset of antenna panels selected from the plurality of antenna panels. The operations include receiving, from the UE, a beam report that includes indices of the subset of antenna panels.

Example 24 may include the one or more processors of Example 23, wherein each of the plurality of antenna panels has a unique number of ports.

Example 25 may include the one or more processors of Example 23 or 24, wherein the signal includes a Radio Resource Control (RRC) signal.

Example 26 may include the one or more processors of any of Examples 23 to 24, wherein the signal includes a Media Access Control (MAC) Control Element (CE).

Example 27 may include the one or more processors of any of Examples 23 to 25, wherein the signal includes Downlink Control Information (DCI)

Example 28 includes a user equipment (UE) in communication with a base station. The UE includes of a receiver that receives, from the base station, a beam report configuration that configures the UE to report measurements for a predetermined number of beam pairs, wherein the one or more beam pairs are arranged in a first Channel Measurement Resource (CMR) set and a second CMR set. The UE includes a processor that determines that the first CMR set corresponds to a first repetition parameter and the second CMR set corresponds to a second repetition parameter. The UE includes a transmitter that transmits, based on the first and second repetition parameters, a beam report to the base station.

Example 29 may include the UE of Example 28, wherein the processor performs the measurements based on the beam report configuration.

Example 30 may include the UE of Example 28 or 29, wherein the processor determines that the first repetition parameter is set to ON and the second repetition parameter is set to OFF.

Example 31 may include the UE of Example 28 or 29, wherein the processor determines that the first repetition parameter is set to ON and the second repetition parameter is set to ON.

Example 32 may include the UE of any of Examples 28 to 31, wherein the first CMR set and the second CMR set are scheduled within one slot in a number of overlapped symbols.

Example 33 may include the UE of any of Examples 28 to 32, wherein the processor processes the first CMR set and the second CMR set in parallel.

Example 34 may include the UE of any of Examples 28 to 31, wherein the first CMR set and the second CMR set are scheduled within one slot without overlapping each other.

Example 35 may include a non-transitory computer-readable media encoded with instructions that, when executed by one or more computers, cause the one or more computers to perform the operations in any of Examples 1 to 27.

Example 36 may include a system having one or more computers and one or more storage devices on which are stored instructions that are operable, when executed by the one or more computers, to cause the one or more computers to perform the operations in any of Examples 1 to 27.

Example 37 may include a method of performing the operations in any of Examples 1 to 27.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors configured to execute instructions that cause a user equipment (UE) to perform operations comprising:
receiving, from a base station, a beam report configuration that configures a UE to report measurements for a predetermined number of beam pairs, wherein the one or more beam pairs are arranged in a first Channel Measurement Resource (CMR) set and a second CMR set;
determining that the first CMR set corresponds to a first repetition parameter and the second CMR set corresponds to a second repetition parameter; and
transmitting, based on the first and second repetition parameters, a beam report to the base station.

2. The one or more processors of claim 1, the operations further comprising:
performing the measurements based on the beam report configuration.

3. The one or more processors of claim 1, the operations further comprising:
determining that the first repetition parameter is set to ON and the second repetition parameter is set to OFF.

4. The one or more processors of claim 3, wherein transmitting, based on the first and second repetition parameters, a beam report to the base station comprises:
reporting a Channel State Information Reference Signal (CSI-RS) Resource Indicator (CRI) for the first CMR set in the beam report; and
determining not to report the CRI for the second CMR set.

5. The one or more processors of claim 3, the operations further comprising:
reporting a Channel State Information Reference Signal (CSI-RS) Resource Indicator (CRI) for both the first CMR set and the second CMR set.

6. The one or more processors of claim 3, the operations further comprising:
reporting a Layer One Reference Signal Received Power (L1-RSRP) for the first CMR set, and
reporting the predetermined number of CRIs/L1-RSRPs for the second CMR set.

7. The one or more processors of claim 1, the operations further comprising:
determining that the first repetition parameter is set to ON and the second repetition parameter is set to ON.

8. The one or more processors of claim 7, the operations further comprising:
reporting a Channel State Information Reference Signal (CSI-RS) Resource Indicator (CRI) for at least one of the first CMR set and the second CMR set.

9. The one or more processors of claim 7, the operations further comprising:
determining not to report a Channel State Information Reference Signal (CSI-RS) Resource Indicator (CRI) for the first CMR set and not to report the CRI for the second CMR set.

10. The one or more processors of claim 7, the operations further comprising:
reporting one Layer One Reference Signal Received Power (L1-RSRP) for either the first CMR set or the second CMR set.

11. The one or more processors of claim 1, wherein the beam report comprises an indicator that indicates whether the UE identifies the beam pairs.

12. The one or more processors of claim 1, wherein the first CMR set and the second CMR set are scheduled within one slot in a number of overlapped symbols.

13. The one or more processors of claim 12, the operations further comprising:
reporting a capability of measuring the overlapped first CMR set and second CMR set.

14. The one or more processors of claim 12, the operations further comprising:
reporting a maximum number of overlapped symbols between the first CMR set and the second CMR set.

15. The one or more processors of claim 12, the operations further comprising:
processing the first CMR set and the second CMR set in parallel using two processors.

16. The one or more processors of claim 1, wherein the first CMR set and the second CMR set are scheduled within one slot without overlapping each other.

17-27. (canceled)

28. A user equipment (UE) in communication with a base station, the UE comprising:
a receiver that receives, from the base station, a beam report configuration that configures the UE to report measurements for a predetermined number of beam pairs, wherein the one or more beam pairs are arranged in a first Channel Measurement Resource (CMR) set and a second CMR set;
a processor that determines that the first CMR set corresponds to a first repetition parameter and the second CMR set corresponds to a second repetition parameter; and
a transmitter that transmits, based on the first and second repetition parameters, a beam report to the base station.

29. The UE of claim 28, wherein the processor performs the measurements based on the beam report configuration.

30. The UE of claim 28, wherein at least one of:
the processor determines that the first repetition parameter is set to ON and the second repetition parameter is set to OFF, or
the processor determines that the first repetition parameter is set to ON and the second repetition parameter is set to ON.

31-37. (canceled)

38. A method comprising:
receiving, from a base station, a beam report configuration that configures a UE to report measurements for a predetermined number of beam pairs, wherein the one or more beam pairs are arranged in a first Channel Measurement Resource (CMR) set and a second CMR set;
determining that the first CMR set corresponds to a first repetition parameter and the second CMR set corresponds to a second repetition parameter; and
transmitting, based on the first and second repetition parameters, a beam report to the base station.
